(19) United States
(12) Patent Application Publication
(10) Pub. No.: US 2014/0180461 A1
(43) Pub. Date: Jun. 26, 2014

(54) REAL-TIME ACTIVITY PLANNING AND MONITORING OF ACTIVITY EXECUTION

(71) Applicants: OLIVER HECK, Leimen (DE); Andreas Daum, Heidelberg (DE); Bernd Ernesti, Wiesloch (DE); Ansgar Haking, Angelbachtal (DE); Markus Kaas, Mannheim (DE); Daren Li, Bad Schoenborn (DE); Dieter Mazanek, Viernheim (DE); Wolfgang Neufing, Frohnhofen (DE); Matthias Pelz, Laudenbach (DE)

(72) Inventors: OLIVER HECK, Leimen (DE); Andreas Daum, Heidelberg (DE); Bernd Ernesti, Wiesloch (DE); Ansgar Haking, Angelbachtal (DE); Markus Kaas, Mannheim (DE); Daren Li, Bad Schoenborn (DE); Dieter Mazanek, Viernheim (DE); Wolfgang Neufing, Frohnhofen (DE); Matthias Pelz, Laudenbach (DE)

(21) Appl. No.: 13/721,244

(22) Filed: Dec. 20, 2012

(51) Int. Cl. G06F 17/00

(52) U.S. Cl. CPC G06F 17/00
USPC 700/97

(57) ABSTRACT

A request to calculate workload for a number of time buckets is received. In response to the request, one or more sets of activities with equal execution timeframe are determined. In one aspect, for the one or more sets of activities, net execution duration of activities from the one or more sets of activities is aggregated to determine workloads of the one or more sets of activities. Planned work time consumption of the determined workloads is calculated. In one aspect, calculated planned work time consumption of the workloads is distributed across the number of time buckets. Distributed planned work time consumption of the workloads is aggregated, by the time buckets to calculate the workload for the time buckets.

### FIELD

Subject matter is drawn to a computerized system and method for planning, monitoring and assigning of resources in an optimal way in order to achieve a business goal.

### BACKGROUND

Planning business activities and monitoring their execution may be crucial to many businesses. Computer systems support and automate such planning and monitoring processes to optimize business activities execution and improve enterprise effectiveness. The planning and monitoring is often done on the level of individual activities or business tasks. However, in some cases a preferred methodology may be to plan and monitor on levels that aggregate the individual activities. For example, planning on aggregate levels may be preferred in cases where, on one hand, multiple resources with equal capabilities are available, and on the other, assigning resources to activities execution is ad-hoc and it is not strictly planned. Such ad-hoc or roughly planned assignment may be due to a very large number of equal resources and/or to certain unpredictability inherent in the execution of the activities. For example, in cases where the activities are not automatically executed (e.g., machine execution), but instead their execution involve large amount of human workforce. In such scenarios it is irrelevant which of the available equal resources will execute the work, and also, the execution of the activities is not planned at a precise time point during the day. Rather, a rough period of time may be defined within which the work is expected to be executed. One example of business entities, for which rough planning on aggregate levels may be suitable, are large warehouses, where numerous equally skilled workers execute warehouse activities.

A common type of business analysis is after-the-fact method of forecasting future performance by examining previous one. Such business analysis requires significant amounts of data, but it may not necessitate real-time reporting. In cases where work execution is only roughly planned, there is flexibility for optimizing the work execution during the execution itself. Therefore, it may be desirable that planning and monitoring on different aggregate levels is done instantaneously and real-time during the execution itself. Each of those different aggregate levels may provide valuable insight on the data being analyzed. However, dynamically analyzing large amounts of data (e.g., million data records of activities) in real-time cannot readily be done.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates an exemplary planning board, according to one embodiment.

FIG. 2 illustrates a first planning view in a first aggregation level, where the first planning view is based on selection criteria, according to one embodiment.

FIG. 3 illustrates a second planning view in a second aggregation level, where the second planning view is based on the selection criteria, according to one embodiment.

FIG. 4 illustrates a third planning view that is based on additional filter criteria and on a time grid with one-hour bucket length, according to one embodiment

FIG. 5 illustrates fourth planning view that is based on the additional filter criteria and on a time grid with half-hour bucket length, according to one embodiment.

FIG. 6 illustrates workloads spread over a timeframe, according to one embodiment.

FIG. 7 illustrates a process to calculate workload within a time range for a number of time buckets, according to one embodiment.

FIG. 8 illustrates workloads overlapping with a time bucket, according to one embodiment.

FIG. 9 illustrates a process to calculate workload for a time bucket, according to one embodiment.

FIG. 10A illustrates workloads overlapping with one or more time buckets, according to one embodiment.

FIG. 10B illustrates aggregated, by time buckets, spread planned work time consumption of workloads, according to one embodiment.

FIG. 11 illustrates system architecture for real-time activity planning and monitoring of activity execution, according to one embodiment.

FIG. 12 is a block diagram of an exemplary computer system according to one embodiment.

### DETAILED DESCRIPTION

Embodiments of techniques for real-time activity planning and monitoring of activity execution are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In scenarios where activities execution is only roughly planned, planned activities may be defined with two dimensions. One time dimension of a planned activity is net execution duration of the activity. Net execution duration represents the period of time necessary for completion of the activity by a unit of manpower (e.g., a warehouse worker). For example, it may take 20 seconds for a warehouse worker to complete a single load or pick activity. There are various methods to determine net execution durations of activities. One method is a simple human estimation, for example, by a manager of the warehouse. Another method is to define the net execution duration based on Engineered Labour Standards (ELS). Such standards may be established by inspection commissions that monitor and track time needed to complete various activities.

When rough planning methodology is used, a period within which the activity can be executed is defined, rather than planning the execution of the activity for exact time point. In one embodiment, an earliest start date and time and a latest end date and time are defined for the execution of an activity. The earliest start date and time and the latest end date and time define the planned execution timeframe within which the activity is expected to be completed. Thus, a leeway is defined when to execute the activity within the timeframe. In addition to the net execution duration, another dimension of a planned activity is the planned work time consumption due to the net execution time of the activity for an individual work resource. The planned work time consumption represents how many resources must be used to complete the activity when the whole possible timeframe is used for the execution. The value of the planned work time consumption of the activity is determined as the net execution duration divided by the time difference between the latest finish time and the earliest start time. For example, a worker may spend 0.5 seconds of work each second from 9 am until 10 pm to complete a specific picking activity which means the planned work time consumption occupies 0.5 work resources. In one aspect, the planned work time consumption of an activity is a different numerical representation of the net execution duration without specific unit of measure with respect to the work time of a resource.

The planning for individual activity instances and their specific execution may not provide as valuable data insight as the planning on aggregate levels. This is especially applicable in cases where multiple resources with equal capabilities are available or where assigning resources to activities execution is ad-hoc and it is not strictly planned. Thus, it may be desirable to monitor and analyze planning data on levels that aggregate individual activities. By analyzing data on a predefined aggregate level, certain insight on the planning data may be gained, however, another may be lost. For example, aggregation on higher levels (e.g., aggregation of the planning data, such as planned workload, to a single aggregate number) may hide planning data that is available on lower aggregate levels. In one embodiment, dynamic aggregations of planned activities on different aggregate levels are implemented. The levels of aggregation may be dynamically changed real-time to allow a resource planner to analyze data real-time via different views of the planning data. In addition, aggregated data may be further analyzed by drilling down the aggregate levels.

Often, date and time information for planning may be formatted or arranged in time grids. A time grid is a pattern of regularly spaced time buckets or time slots. In a time grid, time buckets or slots are ordered in a sequence, where the end time of one slot is the start time of the next slot in the sequence. Thus, there are no time gaps between the slots in the sequence. A time slot is a period, range or interval of time with a starting and finishing time. A time slot is a definite length of time marked or defined by two instants. For example, the time slot may be defined by a start timestamp and an end timestamp of the bucket. In one embodiment, a time slot may be defined by a starting time and time length of the slot. Time slots or buckets in a time grid are typically with regular and equal time length, for example, slots or buckets included in a time grid may be with one hour length, half an hour length, etc.

Aggregations may be calculated not only by aggregating individual activities, but also by applying a time grid. In one embodiment, planned activities are aggregated by time buckets of a time grid. Time grid constraints may be applied on the planned activities to obtain yet another insight on the planning data. Also, aggregating by time buckets of a time grid may define a level of aggregation. Thus, time bucket length defines a dimension based on which planned activities may be dynamically aggregated or disaggregated. In one embodiment, a flexible time grid is applied onto the planning data. The time grid is flexible since planned activities may be aggregated by time buckets of different time length (e.g., 5 minutes, 15 minutes, 30 minutes, 60 minutes, etc.). For example, a resource planner of a warehouse may analyze the amount of expected workload every hour during the day to determine and plan the amount of workforce to assign to execute the corresponding work.

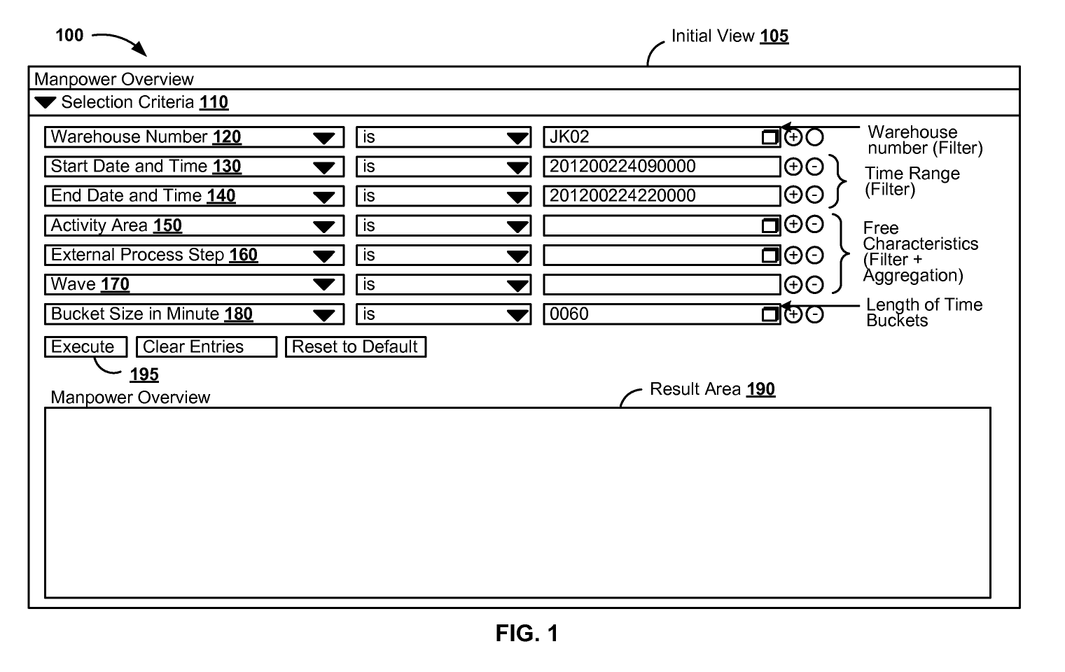

Information relevant to the planning process may be presented in a planning board. FIG. 1 illustrates an exemplary planning board 100, according to one embodiment. A planning board is a graphical overview of planned activities or expected workload. A graphical user interface (GUI) may be used by a resource planner to view planned workload and/or resource assignments and to monitor the execution process of the activities. In FIG. 1, an initial view 105 of planning board 100 is illustrated. In one embodiment, the initial view 105 may be displayed in response to launching planning board 100.

In one embodiment, planning board 100 may represent various planning views on the data being analyzed. For example, a resource planner may examine planned activities and other data being analyzed via views on different aggregate levels and based on different filters. The data may be filtered and aggregated based on various dimensions. Aggregate levels are defined by aggregating planned activities by various dimensions including, but not limited to, activity type, time dimension, area, etc. Various dimensions subject to the specific businesses may also be defined. In one embodiment, the views on different aggregate and filter levels are determined based on values of characteristics of planned activities. In one embodiment, selection criteria 110 include values of such characteristics that may be entered by a resource planner to obtain a planning view onto the planning data.

A characteristic may be an attribute that describes and distinguishes the planned activities. Characteristics may be applied as a criterion that selects or filters data. For example, planned activities may be filtered based on their different characteristics. In one embodiment, a characteristic may be one type of ‘InfoObject’. An ‘InfoObject’ is an information unit in SAP® NetWeaver® Business Warehouse (SAP® BW), provided by SAP AG. In the specific case of planning and monitoring warehouse activities, examples of characteristics include, but are not limited to, a warehouse (e.g., warehouse number 120); an area in a warehouse (e.g., activity area 150) that represents logical section of the warehouse defined based on warehouse activities such as unloading, putaway, replenishment, picking, staging, loading, inventory, etc.; a process step (e.g., external process step 160) such as pick, pack, stage, and load that are steps part of a four-step outbound process; and a wave (e.g., wave 170). A wave is a logical grouping of warehouse activities associated with a certain requested product or delivery to control the grouped warehouse activities. For example, activities may be split or combined into waves to organize their overall processing. Activities may be organized into waves on the basis of criteria such as activity area, route, product, etc. Activities organized in a wave may be expected to be processed at roughly the same time.

In addition to characteristics of the planned activities, other dimensions based on which planned activities may be filtered and aggregated, and which may not be specific to warehouse activities, include a time range and a time bucket size. Start date and time 130 and finish date and time 140 define the time range. Activities that are planned to be executed within the time range are included in the aggregations.

In one embodiment, depending on entered selection criteria 110, aggregated planning data is to be represented in a planning view to be displayed in result area 190. Based on entered values for characteristics 120-180, planned activities are filtered and aggregated. For example, in FIG. 1, value ‘JK02’ is entered as a filter for warehouse number 120. Further, a time range within “09:00-22:00” on date 24.02.2012 is entered. Also, a time length of ‘60’ minutes is specified as a value for bucket size 180. Thus, activities that are associated with warehouse ‘JK02’ and that are planned to be executed within “09:00-22:00” on date 24.02.2012 are to be aggregated by buckets of sixty minutes. Planning data that meets the specified criteria in selection criteria 110 is selected and included in the planning view that is based on the selection criteria 110. Other planned activities that are not associated with warehouse ‘JK02’ or that are planned to occur outside the range entered in selection criteria 110 are filtered out from the planning view. In one embodiment, a planning view that is based on selection criteria 110 may be requested by a resource planner via button ‘Execute’ 195.

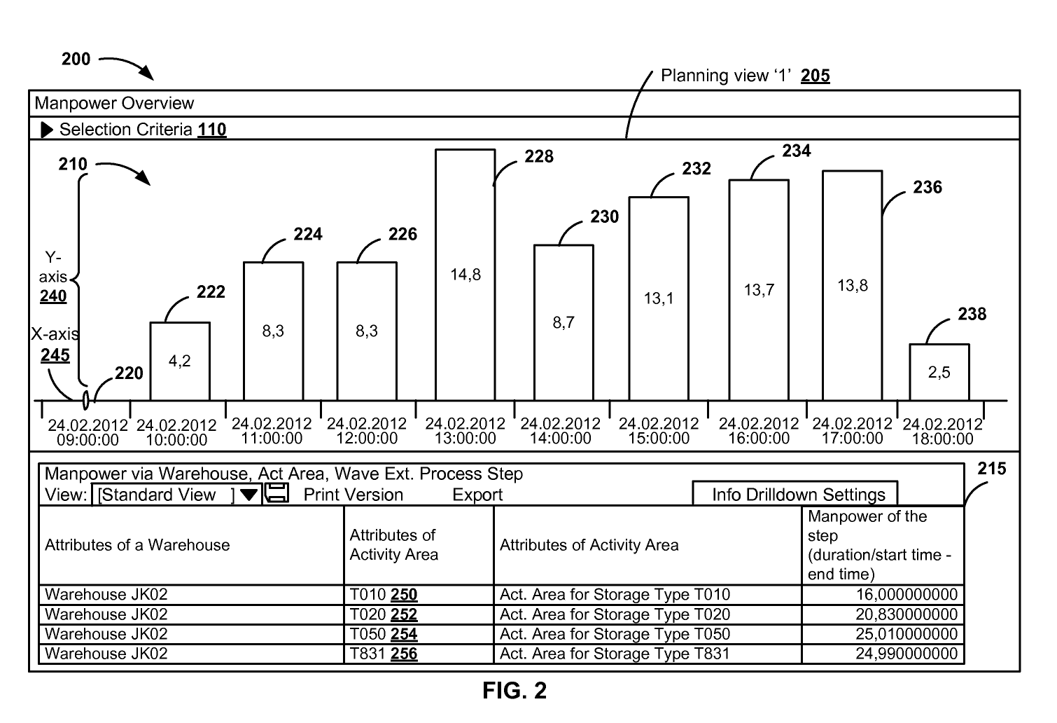

FIG. 2 illustrates an exemplary planning view ‘1’ 205 in a first aggregation level, where planning view ‘1’ 205 is based on selection criteria 110. In response to requesting the planning view based on selection criteria 110, planning data is aggregated and included in a planning view 1′ 205. Planning view ‘1’ 205 graphically represents calculated workload according to selection criteria 110. For example, planning view ‘1’ 205 displays workload of warehouse ‘JK02’ within the time range “09:00-22:00” on date 24.02.2012 as selected and calculated based on filter values for warehouse number 120 and start date and time 130 and end date and time 140 (FIG. 1).

A planned activity may correspond to unit of workload. In one embodiment, a workload is measured in terms of net duration of the activity execution within a planned execution timeframe. A workload may be determined by aggregating planned work time consumption of one or more planned activities. The calculated aggregations indicate the workload that is expected for a specified time range (e.g., within the time range defined by start date and time 130 and end date and time 140 in FIG. 1). One or more units of workload may be executed by one or more units of manpower. Therefore, based on calculated workload, the manpower necessary to execute the workload may be also determined.

In one embodiment, planning board 200 in FIG. 2 includes two graphical user interface building blocks (UIBBs). For example, planning board 200 includes chart-UIBB 210 and list-UIBB 215. In one embodiment, chart-UIBB 210 and list-UIBB 215 are configured to display data retrieved by a business intelligence (BI) query. In the configuration of a UIBB the corresponding BI query that is to be called is specified. In one embodiment, chart-UIBB 210 and list-UIBB 215 are based on data retrieved from two separate BI queries. The BI queries associated with chart-UIBB 210 and with list-UIBB 215 are both based on entered selection criteria 110 in FIG. 1.

Chart-UIBB 210 shows workload as calculated per each time bucket of time buckets 220-238 according to the entered selection criteria 110. For example, the amount of work expected to be executed for warehouse ‘JK02’ within the time bucket with starting time ‘13:00:00’ and finish time ‘14:00:00’ is equal to 14.8, e.g., workload 228. ‘Y-axis’ 240 corresponds to workload values to indicate the workload of the planned warehouse activities aggregated by their planned work time consumption, e.g., workloads 220-238 calculated per each time bucket and determined by summing up planned work time consumption of the planned activities. In one embodiment, when applying time grid constraints onto planned workload, values of planned earliest start time and latest end time of an activity may be dynamically changed to correspond to start and end timestamps of one or more time buckets of the time grid, respectively. For example, planned earliest start time and latest end time of an activity may be rounded to the nearest start and end timestamps of time buckets with which the activity overlaps. Further, if a planned earliest start time of an activity is in the past, i.e. before the current date and time, then the earliest start time of the activity may be rounded to the current date and time. In one embodiment, the current date and time is also compared with start and end timestamps of activities to determine activities that are overdue.

In one embodiment, time buckets are with one hour time length and are ordered in a sequence displayed on ‘X-axis’ 245. The time buckets are determined based on start date and time 130 and bucket size 180 entered as illustrated in FIG. 1, where the start timestamp of the first bucket in the sequence (i.e., time bucket with starting time “09:00:00”) is equal to start date and time 130. The end timestamp of the first bucket in the sequence is determined by adding bucket size 180 to the start timestamp of the bucket. ‘X-axis’ 245 is a time line that is divided according to time buckets.

Workloads 220-238 represent the amount of work that is expected to be executed within the timeframe defined by the time buckets displayed on ‘X-axis’ 245, where planned workloads 220-238 are evenly distributed or spread over the corresponding time buckets. For example, workload 228 represents that one unit of manpower will spend 14.8 minutes of work per minute from “13:00:00” until “14:00:00” o'clock to complete activities associated with workload 228. Thus, to complete the activities within the timeframe “13:00:00-14:00:00”, 14.8 units of manpower have to be assigned to execute the activities associated with workload 228. In one embodiment, workloads 220-238 represent the amount of manpower or other resources necessary to be utilized in parallel to complete the corresponding work or activities.

In chart-UIBB 210 data is aggregated by time bucket size 180 (FIG. 1). It is possible to filter the data that is displayed in chart-UIBB 210 by entering filter values for selection criteria 110, but the displayed calculated workload would be still aggregated. Whereas, in list-UIBB 215, the calculated workload can be disaggregated by free characteristics. Free characteristics are characteristics by which displayed data can be further drilled down. For example, in FIG. 1 free characteristics are activity area 150 and external process step 160. In one embodiment, chart-UIBB 210 displays retrieved data on higher aggregation level, while list-UIBB 215 displays data on lower aggregation level, and where in list-UIBB 215 the displayed data can be further disaggregated. In one aspect, aggregation or disaggregation along free characteristics is analogous to applying flexible time grid onto the planning data.

List-UIBB 215 may illustrate the same amount of workload as that in chart-UIBB 210, but on different aggregation level. In one embodiment, in list-UIBB 215, calculated workload is disaggregated initially by a single free characteristic (e.g., activity area 150 in FIG. 1). For example, workload of warehouse ‘JK02’ within the time range “08:00-22:00” on date 22.02.2012 is disaggregated by activity area, e.g., workload associated with activity areas ‘T010’ 250, ‘T020’ 252, ‘T050’ 254, and ‘T831’ 256 are displayed. Further aggregating or disaggregating by free characteristics in list-UIBB 215 does not change data displayed in chart-UIBB 210, since chart-UIBB 210 and list-UIBB 215 are associated with two separate BI queries. In one aspect, chart-UIBB 210 illustrates highly aggregated workload to provide overview onto the workload of a warehouse, while list-UIBB 215 can be used to drill down into more details based on the insight gained from chart-UIBB 210. Thus, chart-UIBB 210 and list-UIBB 215 may provide to a resource planner complementary insight regarding planned activities. Further, in one embodiment, performance optimizations may be implemented that are tailored to either chart-UIBB 210 or list-UIBB 215.

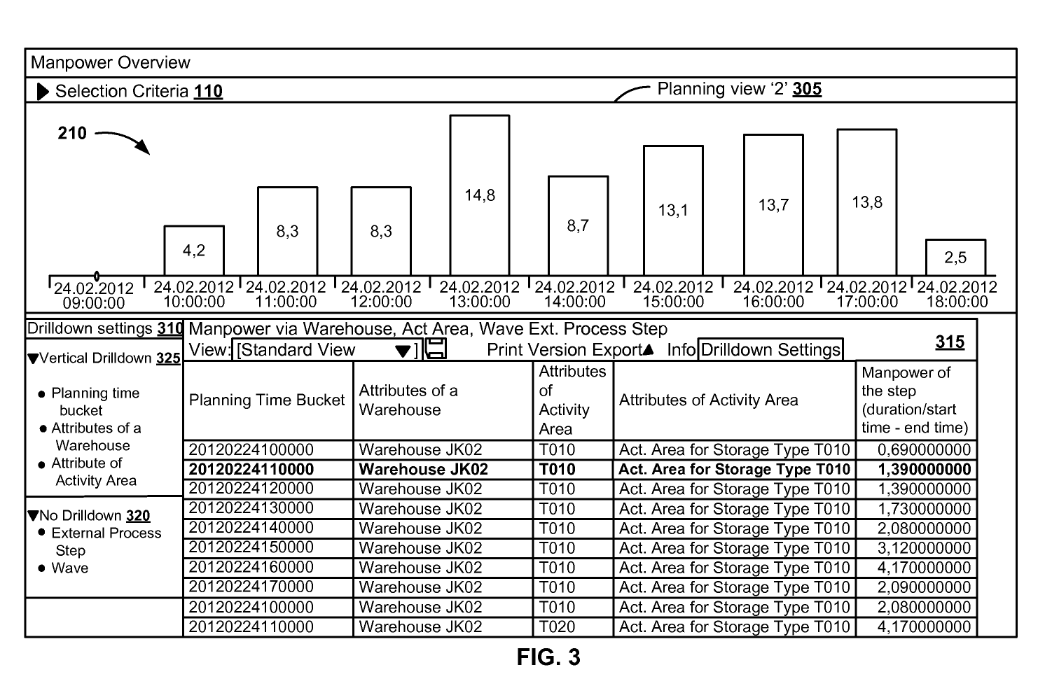

FIG. 3 illustrates an exemplary planning view ‘2’ 305 on a second aggregation level, where planning view ‘2’ 305 is also based on selection criteria 110. The amount of workload displayed in list-UIBB 215 is the same as in planning view ‘1’ 205, but the workload in list-UIBB 215 in planning view ‘2’ 305 is displayed on another aggregation level. For example, the aggregation level of a free characteristic, e.g., planned earliest start time, is changed as planned start time characteristic is disaggregated, whereas in list-UIBB 215 of planning view ‘1’ 205 in FIG. 2 planned start time characteristic is not disaggregated. Aggregated and disaggregated free characteristics can be specified in drilldown settings 310. In current planning view ‘2’ 305, drilldown settings 310 display which free characteristics are aggregated (e.g., in graphical area ‘No drilldown’ 320) and which are disaggregated (e.g., in graphical area ‘Vertical drilldown’ 325).

List-UIBB 215 in planning view ‘1’ 205 is changed to list-UIBB 315 in planning view ‘2’ 305 by disaggregating the workload by planning time bucket. In one embodiment, when applying time grid constraints onto planned activities, earliest start time of the activities may be rounded to correspond to start timestamps of time buckets of the time grid. Thus, list-UIBB 315 displays the amount of workload per activity area per time buckets. By changing aggregation level, list-UIBB 315 in planning view ‘2’ 305 displays more detailed information in comparison to list-UIBB 215 in planning view ‘1’ 205 of FIG. 2. For example, in planning view ‘2’ 305 it is displayed that ‘1.39’ manpower is required in area ‘T010’ in the planning time bucket starting at ‘11:00’. In one embodiment, chart-UIBB 210 remains unchanged, when changing aggregation level in list-UIBB 215.

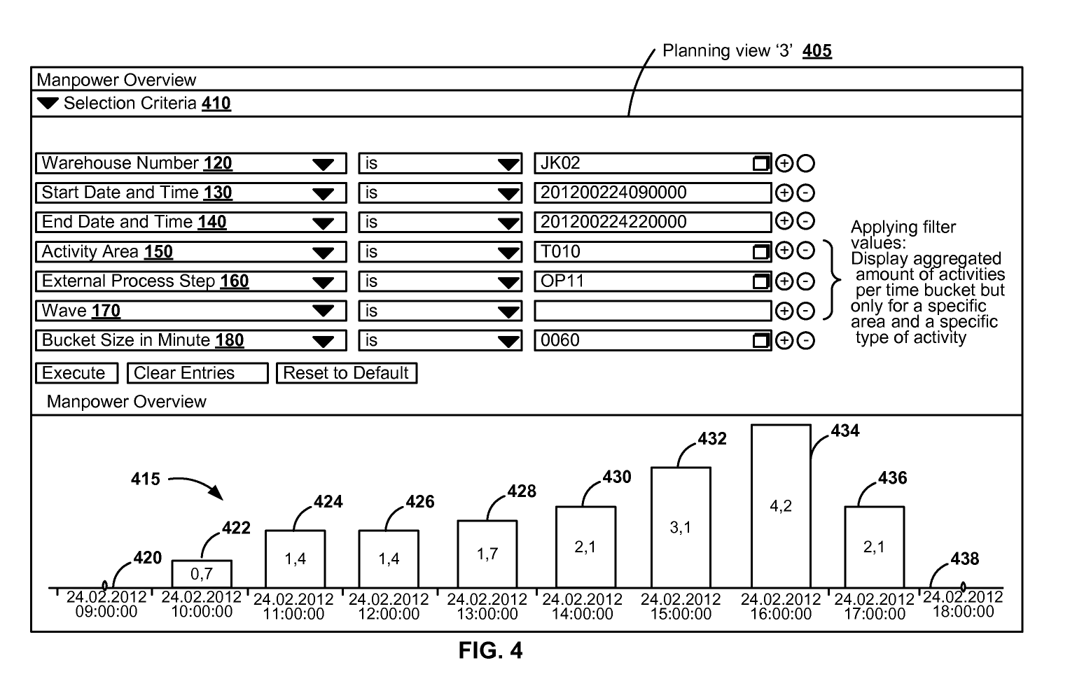

FIG. 4 illustrates planning view ‘3’ 405 that is based on additional filter criteria, according to one embodiment. Selection criteria 410 include filter values as in selection criteria 110 for characteristics 120, 130, 140, and 180. In planning view ‘3’ 405, an additional filter criteria is included in selection criteria 410 by specifying filter values for characteristics 150 and 160. For example, value ‘T010’ is entered for characteristic activity area 150 and value ‘OP11’ is entered for characteristic external process step 160. Chart-UIBB 415 displays the amount of workload for each time bucket for specific activity area (i.e., ‘T010’) and for specific type of activity (i.e., ‘OP11’). For example, chart-UIBB 415 displays workloads 420-438. In criteria 410, the warehouse number 120 and the time range based on start date and time 130 and end date and time 140 are the same as in criteria 110. Because of the additional filter criteria included in selection criteria 410, workloads 422-436 are reduced in comparison to workloads 222-236. For example, activities that are associated with activity area different than ‘T010’ or type of activity different than ‘OP11’ are filtered from calculated workloads 222-236.

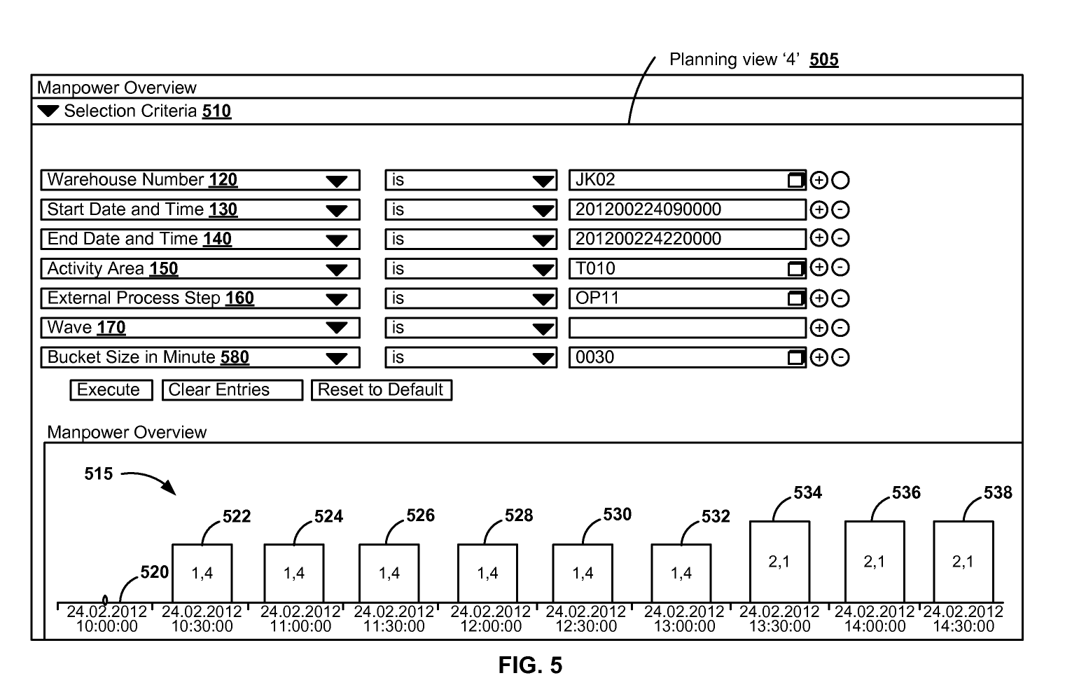

FIG. 5 illustrates planning view ‘4’ 505 that is based on a time grid with half-hour bucket size, according to one embodiment. In chart-UIBB 515 of planning view ‘4’ 505 that is based on selection criteria 510, workloads 520-538 are displayed. In selection criteria 510 filter values for characteristics 120-170 are the same as in selection criteria 410 in FIG. 4. Chart-UIBB 515 in planning view ‘4’ 505 displays workload based on the same filter as chart-UIBB 415 in planning view ‘3’ 405, but on different aggregation level, e.g., based on bucket size with shorter time length. For example, bucket size 180 with value 60 minutes in planning view ‘3’ 405 in FIG. 4 is changed to bucket size 580 with value 30 minutes in planning view ‘4’ 505 in FIG. 5. In one embodiment, planning view ‘4’ 505 illustrates workload, which is calculated based on the same amount of activities (as selected in planning view ‘3’ 405), but within shorter timeframes for their execution, i.e., within 30 minutes instead of 60 minutes. In one embodiment, in a planning view based on shorter timeframes, the calculated workload can be increased in proportion to decreased timeframes for execution of the activities. The reverse can also be true, in planning view based on longer timeframes the calculated workload is decreased in proportion to increased timeframes for execution of the activities, according to one embodiment. For example, in planning view ‘3’ 405 the expected workload 422 within timeframe “10:00:00-11:00:00” equals ‘0.7’, whereas, in planning view ‘4’ 505 the calculated workload 522 within timeframe “10:30:00-11:00:00” equals ‘1.4’. The calculated workload 522 is doubled because it is based on the same amount of activities, but the execution timeframe of the activities is adjusted to two times shorter timeframe. Whether the workload is increased in proportion to the decreased execution timeframes depends on the bucket size and on the starting time point of the execution timeframe of the activities associated with the workload.

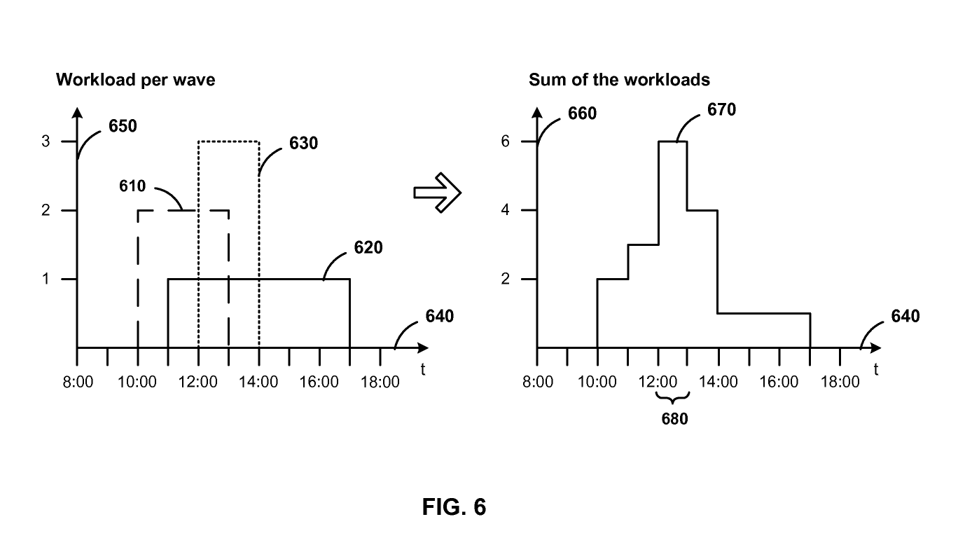

FIG. 6 illustrates workloads 610-630 spread over a timeframe, according to one embodiment. Execution of an activity is not planned for exact time point. A planned execution timeframe within which workload is expected due to execution of the activity is associated with the workload. In one embodiment, planned execution timeframe of workload 610 is the time range “10:00-13:00” where planned earliest start time is “10:00” and planned latest end time is “13:00”; planned execution timeframe of workload 620 is the time range “11:00-17:00” where planned earliest start time is “11:00” and planned latest end time is “17:00”; and planned execution timeframe of workload 630 is the time range “12:00-14:00” where planned earliest start time is “12:00” and planned latest end time is “14:00”. Time axis 640 represents a time grid that includes a sequence of time buckets with one hour length within the time range “08:00-18:00”, where the start time of a bucket in the sequence is equal to the end time of a previous bucket in the sequence.

A workload may correspond to a single activity, and be defined by the net execution duration of the activity and the planned timeframe for execution of the activity. In one embodiment, a workload that corresponds to a single activity may be measured or represented by the planned work time consumption of the activity. Planned work time consumption of the activity is the net execution duration of the activity spread over the planned timeframe. In addition, a workload may also be determined based on multiple activities. In one embodiment, a workload may be determined based on multiple activities with equal planned timeframe for their execution. For example, each workload of workloads 610-630 may be determined based on a set of 360 tasks or activities. Each activity may have net execution duration of 1 minute. Each set of these three sets of 360 activities includes activities that are planned to be executed within equal timeframe. In the case of planning and monitoring warehouse activities, activities of workload 610 may represent the activities of a first wave, activities of workload 620 may represent the activities of a second wave, and activities of workload 630 may represent the activities of a third wave. Equal timeframe for execution of the 360 activities of each wave may be defined by the starting or release time of the corresponding wave and the completion time of the wave.

In case where the workload is determined based on multiple activities, the workload may be measured or represented, on one hand, by the corresponding equal execution timeframe of the activities and, on the other, by aggregation of planned work time consumption of the activities. A workload that is based on multiple activities may be represented by spreading the aggregation of net execution duration of the activities over the corresponding timeframe. For example, for workload 630, 6 hours of aggregated net execution duration of activities are spread over 2 hours of timeframe (i.e., time range “12:00-14:00”). In one embodiment, aggregated net execution duration of the activities that are spread over the corresponding planned execution timeframe of the workload represent the planned work time consumption of the workload. Thus, the planned work time consumption of the workload is the workload distributed evenly between the earliest start time and latest finish time of the planned execution timeframe. In one embodiment, a time dependent workload function may calculate the workload, and thus, the planned work time consumption of the workload, by dividing the aggregation of net execution duration of the activities by the timeframe length (e.g., by the time difference between the latest end time and the earliest start time of the timeframe). For example, planned work time consumption of workload 630 is calculated by the time dependent workload function by dividing 6 hours of aggregated net execution duration of activities by 2 hours of execution timeframe. Thus, planned work time consumption of workload 630 equals 3 minutes of work each minute of the two-hour timeframe representing the need of 3 resources. Similarly, planned work time consumption of workload 610 is calculated by dividing 6 hours of aggregated net execution duration of activities by 3 hours of timeframe. Thus, planned work time consumption of workload 610 equals 2 minutes of work each minute of the timeframe representing the need of 2 resources. Planned work time consumption of workload 620 is calculated by dividing 6 hours of aggregated net execution duration of activities by 6 hours of timeframe. Thus, planned work time consumption of workload 620 equals 1 minute of work each minute of the timeframe representing the need of 1 resource. Workload axis 650 may represent planned work time consumption.

In one embodiment, a time grid is applied on workloads 610-630. Planned work time consumptions of workloads 610-630 are aggregated or summed up by time buckets of the time grid represented on time axis 640 to calculate workload for the time buckets. For example, overall workload 670 for time bucket 680 is calculated by aggregating planned work time consumptions of workloads 610-630 for time bucket 680. Planned work time consumption of 1 of workload 620, planned work time consumption of 2 of workload 610, and planned work time consumption of 3 of workload 630 are summed up to calculate expected workload 670 within the range represented by time bucket 680 (i.e., 6 minutes of work each minute of the one-hour time bucket 680 representing the need of 6 resources). In one aspect, workload axis 660 represents planned work time consumption of workloads summed up or aggregated by the time buckets on time axis 640. In another aspect, workload axes 650-660 also represent unit of manpower or other resources necessary to execute corresponding workloads.

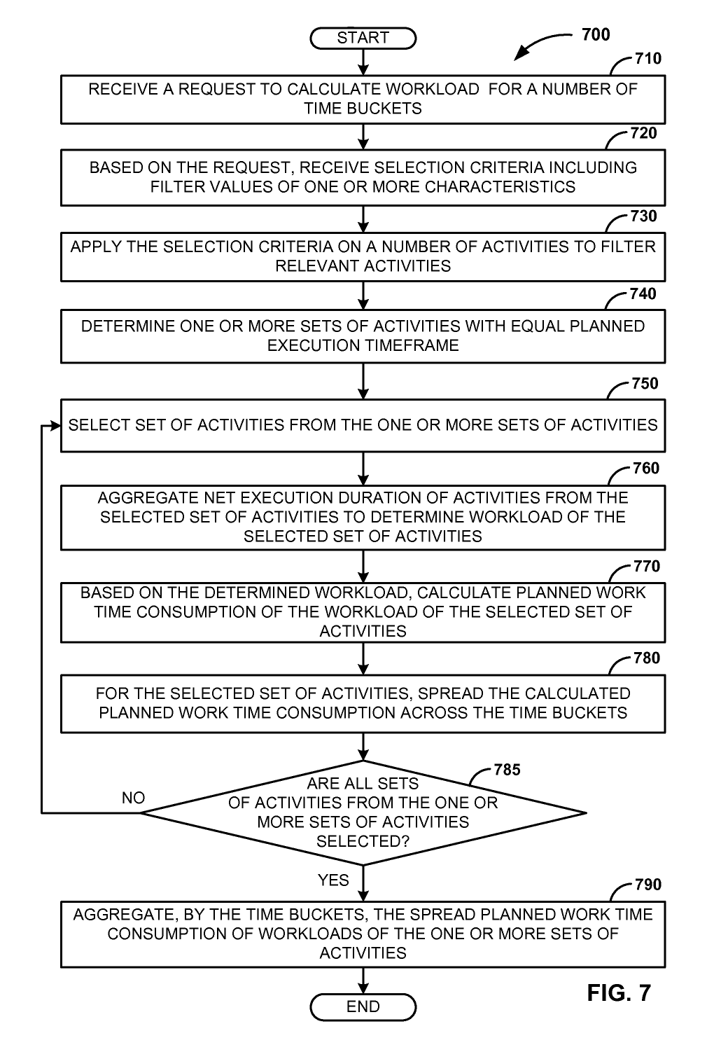

FIG. 7 illustrates process 700 to calculate workload within a time range for a number of time buckets, according to one embodiment. At 710, a request to calculate workload for a number of time buckets is received. In one embodiment, the time buckets are with regular or predefined time length and are ordered in a sequence in a time grid, where the start timestamp of a bucket equals the end timestamp of a previous bucket in the sequence. In one embodiment, in response to the request, a database table for the number of time buckets is dynamically generated. In one embodiment, the table with the time buckets may be an in-memory database table in column store format. The table for the time buckets includes columns for start timestamp and end timestamp of each requested bucket. In one embodiment, the regular time length of the time buckets may also be specified in the request. In another, embodiment, a default regular time length for time buckets may be assigned, for example, time length of one hour. In one embodiment, time buckets start and end timestamps are calculated based on the specified in the request start time of the time range and the regular time length of the buckets.

At 720, based on the request, selection criteria (e.g., selection criteria 110, 410, and 510) are received that include filter values for one or more characteristics. At 730, the selection criteria are applied on a number of activities to filter relevant activities. Based on the selection criteria, relevant activities that are planned to be executed within the time range are selected to be aggregated and included in the calculation of the workload. If planned latest end time of an activity is already in the past, then the activity is overdue. If planned earliest start time of an activity is in the past, but the latest finish time is still in the future, a check is performed if the time difference between the current time and the latest finish time is smaller than the net execution time of the activity. If the time difference between the current time and the latest finish time is smaller than the net execution time of the activity, then the activity is overdue. In one embodiment, activities that are overdue are filtered and are not included in the calculation of the workload. In another embodiment, overdue activities may be aggregated in a bucket with overdue activities. In one embodiment, if planned earliest start time of an activity is in the past, but the activity is not yet overdue, the planned earliest start time of the activity is rounded to the current date and time and the activity is selected to be aggregated and included in the calculation of the workload. Thus, not only activity planning but also activity execution is analyzed and monitored.

In one embodiment, the selection criteria are applied on an in-memory database workload table in column store format containing a number of workloads or activity records. Table that is column store based may allow fast calculations of aggregations of column values of many rows. Examples of fields or attributes, which are technically table columns, of the workload table include, but are not limited to, a warehouse number, net execution duration, earliest start timestamp, and latest end timestamp, etc. According to the selection criteria, workload records and fields that are relevant to selection criteria are selected. In one embodiment, selected relevant workload records and fields are retained in a temporary workload table to reduce the number of data records for further calculations and aggregations. If additional filters for at least one free characteristic are included in the received selection criteria, the temporary workload table is further reduced according to the selection criteria.

At 740, one or more sets of one or more activities of the selected relevant activities that are with equal planned execution timeframe are determined. Examples of the one or more sets of activities that are with equal execution timeframe may correspond to workloads 610-630 in FIG. 6. In one embodiment, the one or more sets of activities with equal execution timeframe are determined from activities included in the temporary workload table.

At 750, a set of activities from the one or more sets of activities is selected. At 760, net execution duration of activities from the selected set of activities is aggregated to determine workload of the selected set of activities. At 770, based on the determined workload of the selected set of activities, planned work time consumption of the workload of the selected set of activities is calculated. To calculate the planned work time consumption of the workload, the aggregation of the net execution duration of the activities is distributed evenly within or spread longitudinally over the equal execution timeframe of the selected set of activities. In one embodiment, a time dependent workload function calculates the planned work time consumption of the workload of the selected set of activities. The time dependent workload function, for points in time that belong to the corresponding equal execution timeframe of the selected set of activities, equals the aggregated sum of the net execution duration of the activities divided by time difference between planned latest finish time and planned earliest start time of the equal execution timeframe (e.g., the time difference between start timestamp and end timestamp of the planned execution timeframe). In one embodiment, the time dependent workload function distributes evenly the aggregated net execution duration within the corresponding execution timeframe of the selected set of activities. In one aspect, the time dependent workload function calculates the number of units of manpower necessary to perform work in parallel to complete the activities of the selected set of activities, where the work is performed continuously throughout the execution timeframe, e.g., the units of manpower work every second or every minute of the timeframe to complete the activities.

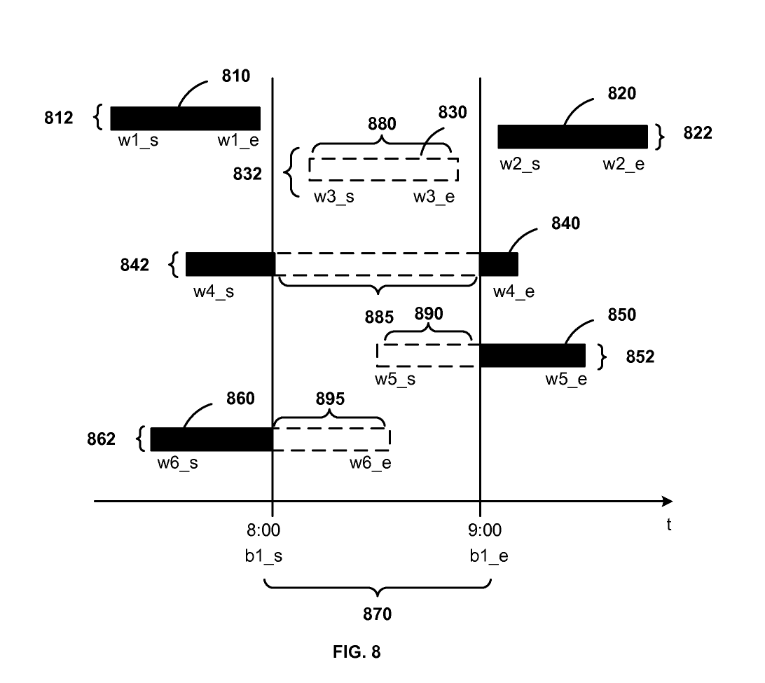

At 780, the calculated planned work time consumption of the workload of the selected set of activities is spread across the time buckets. In one embodiment, the calculated planned work time consumption of the workload is spread across time buckets with which the workload overlaps. A workload overlaps with a time bucket if the planned execution timeframe of activities included in the workload overlaps with the time period of the time bucket. For example, a workload overlaps with a time bucket if a time point of the planned execution timeframe of the workload belongs to the time period of the time bucket. FIG. 8 illustrates workloads overlapping with one or more time buckets. A proportionate ratio of the planned work time consumption of the workload is assigned to a corresponding overlapping time bucket. The ratio is determined by the portion of the workload overlapping with the time bucket. Then, in case the execution timeframe of the workload starts or ends within the bucket, the assigned proportionate ratio is normalized by the length of the corresponding overlapping time bucket and it is spread over the length of the time bucket.

For example, with reference to FIG. 8, since planned execution timeframe of workload 830 is within time bucket 870, then the whole planned work time consumption 832 is assigned to time bucket 870, e.g., the proportionate ratio equals the whole workload. Further, since the execution timeframe of workload 830 starts or ends within bucket 870, then planned work time consumption 832 of workload 830 is spread over or distributed evenly within time bucket 870. In one aspect, a convolution of the time grid and the time dependent workload function is calculated to spread longitudinally the calculated planned work time consumption of the workload across overlapping time buckets. In case the execution timeframe of the workload starts before the start time of the time bucket and ends after the end time of the time bucket, the assigned proportionate ratio of planned work time consumption is already normalized and distributed evenly within the time bucket. For example, with reference to FIG. 8, ratio of the planned work time consumption 842 of workload 840 that is proportionate to portion 885 of workload 885 that overlaps with time bucket 870 is assigned to time bucket 870.

In one embodiment, in response to the aggregation of the net execution duration of the activities of each selected set and the calculation of the planned work time consumption of the workload of each selected set, the temporary workload table contains a workload record for each set of activities with equal execution time frame. In one embodiment, to spread the calculated planned work time consumption of workloads for the one or more sets of activities, an inner join of the temporary workload table and the calculated time buckets table is performed. The inner join results in a table containing a record for every workload that overlaps with a time bucket. For example, if a workload overlaps with three time buckets, then three records will be created as a result of the inner join.

At 785, a check is performed to determine whether all sets of activities of the one or more sets of activities are selected. In case there are unselected sets of activities, the process 700 continues with step 750. When planned work time consumption of workloads for the one or more sets of activities are calculated and spread across the time buckets, process 700 continues at 790. At 790, the spread planned work time consumption of workloads of the one or more sets of activities are aggregated or summed up by the time buckets of the time grid. Thus, planned work time consumption assigned and spread over the time buckets, are aggregated by the time buckets to determine workload for the number of time buckets.

FIG. 8 illustrates one or more of workloads 810-860 overlapping with time bucket 870. In one embodiment, a request to calculate workload for time bucket 870 may be received. Time bucket 870 is defined by start timestamp ‘b1_s’ at 8:00 and end timestamp ‘b1_e’ at 9:00. To calculate workload for time bucket 870, workloads that overlap with time bucket 870 are determined.

In FIG. 8, workloads 810-860 and time bucket 870 are illustrated. Workload 830 defined by planned earliest start timestamp ‘w3_s’ and planned latest end timestamp ‘w3_e’ overlaps with time bucket 870, since both planned earliest start timestamp ‘w3_s’ and planned latest end timestamp ‘w3_e’ are points in time that belong to time bucket 870. Workload 840 overlaps with bucket 870, since planned earliest start timestamp ‘w4_s’ occurs before start timestamp ‘b1_s’ and planned latest end timestamp ‘w4_e’ occurs after end timestamp ‘b1_e’, Workload 850 defined by planned earliest start timestamp ‘w5_s’ and planned latest end timestamp ‘w5_e’ overlaps with time bucket 870, since planned earliest start timestamp ‘w5_s’ is point in time that belongs to time bucket 870. Workload 860 defined by planned earliest start timestamp ‘w6_s’ and planned latest end timestamp ‘w6_e’ overlaps with time bucket 870, since planned latest end timestamp ‘w6_e’ is point in time that belongs to time bucket 870. Planned work time consumption 812, 822, 832, 842, 852, and 862 of workloads 810-860 for illustrative purposes are shown on the y-axis of workloads 810-860 (i.e., height of workloads 810-860), respectively. Planned timeframe for execution of workloads 810-860 are represented on the x-axis (i.e., length of workloads 810-860).

An overlapping portion of a workload with a time bucket is a period of time of planned execution timeframe of activities included in the workload that coincides with the time interval of the time bucket. For example, the overlapping portion of workload 830 with time bucket 870 is the whole workload 830, i.e., portion 880; the overlapping portion of workload 840 with time bucket 870 is portion 885; the overlapping portion of workload 850 with time bucket 870 is portion 890; and the overlapping portion of workload 860 with time bucket is portion 895. Workload 810 defined by start timestamp ‘w1_s’ and end timestamp ‘w1_e’ and workload 820 defined by start timestamp ‘w2_s’ and end timestamp ‘w2_e’ do not overlap with time bucket 870.

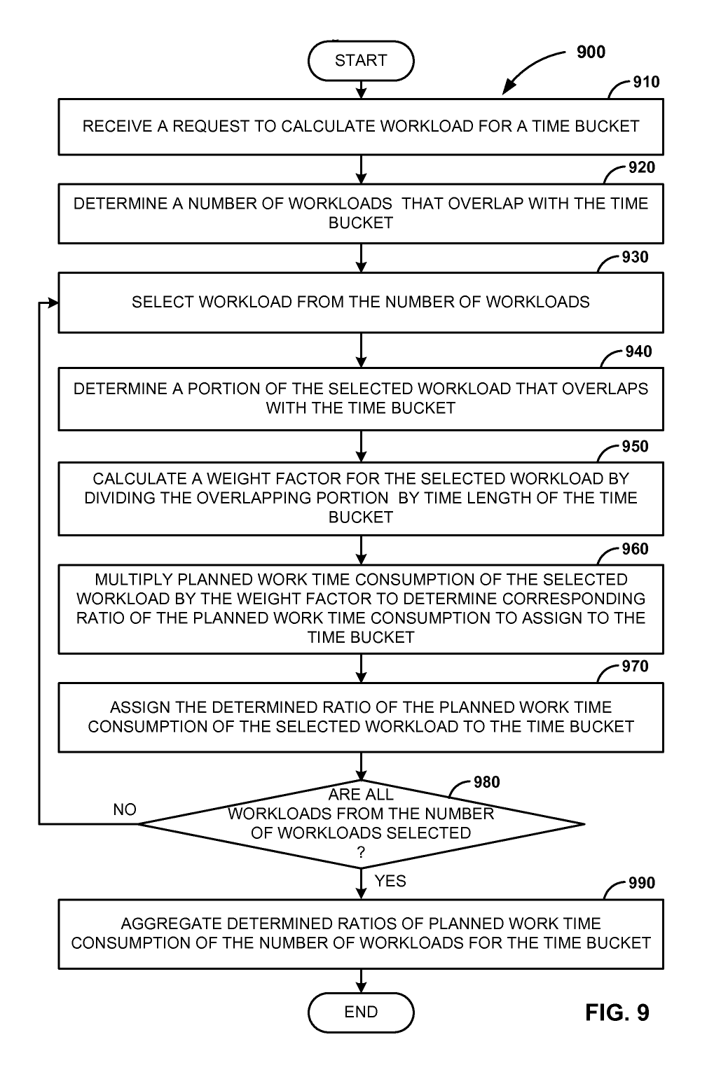

FIG. 9 illustrates a process 900 to calculate workload for a time bucket, according to one embodiment. At 910, a request to calculate workload for a time bucket is received. The time bucket is defined by a start timestamp and an end timestamp. In response to the request, at 920, a number of workloads that overlap with the time bucket are determined. In one embodiment, to determine if a workload overlaps with the time bucket the following check is performed: if workload start timestamp is smaller than bucket end timestamp and workload end timestamp is larger than bucket start timestamp, then the workload overlaps with the time bucket. For example, workloads 830, 840, 850, and 860 are workloads overlapping with bucket 870. Workloads that do not overlap with the time bucket are filtered out.

At 930, workload from the number of workloads that overlap with the time bucket is selected. At 940, a portion of the selected workload that overlaps with the time bucket is determined. In one embodiment, to determine the portion of the workload that overlaps with the time bucket the following cases are evaluated.
Case (1): workload start timestamp is larger or equal to bucket start timestamp and workload end timestamp is larger than bucket end timestamp
Case (2): workload start timestamp is smaller than bucket start timestamp and workload end timestamp is smaller or equal to bucket end timestamp;
Case (3): workload start timestamp is larger or equal to bucket start timestamp and workload end timestamp is smaller or equal to bucket end timestamp; and
Case (4): workload start timestamp is smaller than bucket start timestamp and workload end timestamp is larger than bucket end timestamp.

If the selected workload satisfies case (1), then the portion of the workload that overlaps with the time bucket is determined by the time difference between bucket end timestamp and workload start timestamp. For example, portion 890 of workload 850 that overlaps with time bucket 870 is determined by the time difference between ‘b1_e’ and ‘w5_s’ (i.e., ‘b1_e’-‘w5_s’). If the selected workload satisfies case (2), then the portion of the workload that overlaps with the time bucket is determined by the time difference between workload end timestamp and bucket start timestamp. For example, portion 895 of workload 860 that overlaps with time bucket 870 is determined by the time difference between ‘w6_e’ and ‘b1_s’ (i.e., ‘w6_e’-‘b1_s’). If the selected workload satisfies case (3), then the portion of the workload that overlaps with the time bucket is determined by the time difference between workload end timestamp and workload start timestamp. For example, portion 880 of workload 830 that overlaps with time bucket 870 is determined by the time difference between ‘w3_e’ and ‘w3_s’ (i.e., ‘w3_e’-‘w3_s’). If the selected workload satisfies case (4), then the portion of the workload that overlaps with the time bucket is determined by the time difference between bucket end timestamp and bucket start timestamp. For example, portion 885 of workload 840 that overlaps with time bucket 870 is determined as the time difference between ‘b1_e’ and ‘b1_s’ (i.e., ‘b1_e’-‘b1_s’).

At 950, a weight factor for the selected workload is calculated. The weight factor is calculated by dividing the overlapping portion of the workload by the time length of the bucket. If planned execution timeframe of a workload spans across multiple time buckets, then a ratio of the planned work time consumption of the workload that is proportionate with a corresponding overlapping portion of the workload is assigned to the respective time buckets. A ratio of the planned work time consumption of the workload that is proportionate with the overlapping portion is determined based on the weight factor. At 960, planned work time consumption of the selected workload is multiplied by the weight factor to determine corresponding ratio of the planned work time consumption to assign to the time bucket. At 970, the determined ratio of the planned work time consumption of the selected workload is assigned to the time bucket.

At 980, a check is performed to determine whether all workloads from the number of workloads that overlap with the time bucket are selected. In case there are unselected workloads, the loop continues with step 930, until all workloads from the number of workloads that overlap with the time bucket are selected. Once the determined ratios of the planned work time consumption of the number of workloads are assigned to the time bucket, at 990, the assigned ratios of the planned work time consumption of the number of workloads are aggregated to determine the workload for the time bucket.

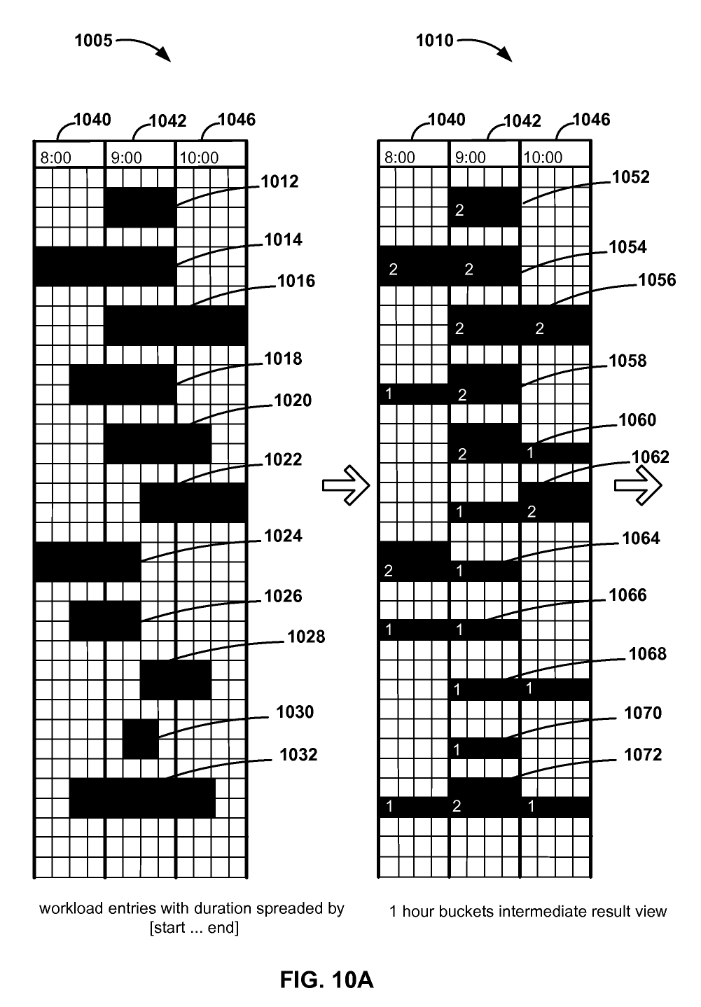

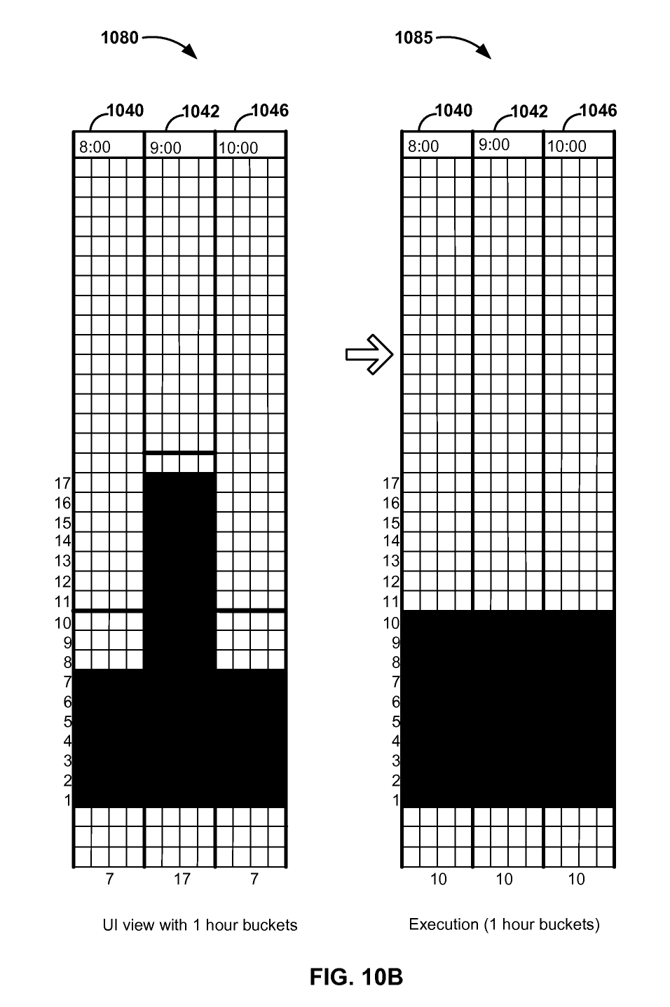

FIG. 10A illustrates workloads 1012-1032 overlapping with one or more of time buckets 1040-1046, according to one embodiment. In one embodiment, workloads 1012-1032 may be based on one or more activities with equal execution timeframe. For illustration purposes, the length of workloads 1012-1032 indicates the time length of the corresponding execution timeframe. For example, time length of workload 1018 is represented with 6 squares or units on the horizontal. For illustration purposes, heights of workloads 1012-1032 indicate planned work time consumption of corresponding workloads 1012-1032. For example, planned work time consumption of workload 1018 is represented with 2 squares or units on the vertical. In time grid 1005 in FIG. 10A, planned work time consumption of workloads 1012-1032 are illustrated (on the vertical) to represent workloads that are evenly distributed over or normalized by the corresponding execution timeframes. In one embodiment, according to process 700 shown in FIG. 7, workloads 1012-1032 are calculated with the time dependent workload function by distributing evenly the aggregated net execution duration of the set of activities associated with corresponding workloads 1012-1032 within their corresponding execution timeframe.

In one embodiment, portions of workloads 1012-1032 that overlap with time buckets 1040-1046 are determined. Based on the determined portions, ratios of the planned work time consumption of workloads 1012-1032 proportionate to the corresponding portions are assigned to corresponding time buckets 1040-1046. The ratios of planned work time consumption of workloads 1012-1032 are spread across their corresponding time buckets 1040-1046. In one embodiment, in time grid 1010, workloads 1052-1072 represent the ratios of planned work time consumption of workloads 1012-1032 that are assigned and spread across time buckets 1040-1046. For example, workload 1018 overlaps with time bucket 1040 and time bucket 1042. Overlapping portion of workload 1018 with time bucket 1040 is equivalent to 2 squares or units of length. To determine the corresponding ratio of workload 1018 to assign to time bucket 1040, weight factor is calculated. The weight factor is calculated by dividing overlapping portion of 2 units of workload 1018 by the time length of bucket 1040 that is equivalent to 4 squares or units. Thus, the weight factor equals 0.5 units. To determine the corresponding ratio of workload 1018 to assign to time bucket 1040, planned work time consumption of 2 units of workload 1018 is multiplied by the weight factor, i.e., 2 units of planned work time consumption is multiplied by 0.5 units of weight factor. The product of the multiplication is the corresponding ratio of planned work time consumption of workload 1018 to be assigned to time bucket 1040, i.e., 1 unit. Similarly, to determine the corresponding ratio of workload 1018 to assign to time bucket 1042, another weight factor is calculated. However, since length of time bucket equals the portion of the execution timeframe of workload 1018, the weight factor equals 1 unit. Thus, 2 units of planned work time consumption is multiplied by 1 unit of weight factor, i.e., 2 units of planned work time consumption of workload 1018 are to be assigned to time bucket 1042. Since, overlapping portion of workload 1018 with time bucket 1042 coincides wholly with bucket 1042, then no normalization or spreading is needed. Workload 1058 represents workload 1018 spread over time buckets 1040-1042 with which workload 1018 overlaps. In one aspect, a convolution of time grid 1005 and the time dependent workload function is represented in time grid 1010.

FIG. 10B illustrates aggregated, by buckets 1040-1046, spread planned work time consumption of workloads 1052-1072, according to one embodiment. Ratios of planned work time consumption of workloads 1052-1072 that are assigned to one or more of time buckets 1040-1046 in FIG. 10A are aggregated by time buckets 1040-1046. For example, to determine workload associated with time bucket 1040, ratios of planned work time consumption of workloads 1054, 1058, 1064, 1066, and 1072 assigned to time bucket 1040 in FIG. 10A are aggregated or summed up. As illustrated in time grid 1080, the aggregation of weighted planned work time consumption of workloads 1054, 1058, 1064, 1066, and 1072 assigned to time bucket 1040 equals 7 units of workload or manpower. Similarly, 17 units and 7 units of workload or manpower are calculated for buckets 1042 and 1046, respectively. In one embodiment, a resource planner when analyzing the calculated workload displayed in time grid 1080, may determine how to optimally distribute manpower. For example, 17 units of workload associated with bucket 1042 is with 10 units more than the 7 units of workload associated with neighboring buckets 1040 and 1046. Since this is unequal distribution of workload across buckets, a resource planner may conclude that more even distribution of the work across the time buckets is necessary. To further analyze how the workload can be more evenly distributed, the resource planner may drill down in the list-UIBB of the planning view (e.g., list-UIBB 315 in FIG. 3), which provides insights on more detailed level comparable to data shown in time grid 1080 and helps the resource planner to more finely adjust start times of individual or groups of activities. Time grid 1085 represents more optimal distribution of the workload across buckets 1040-1046.

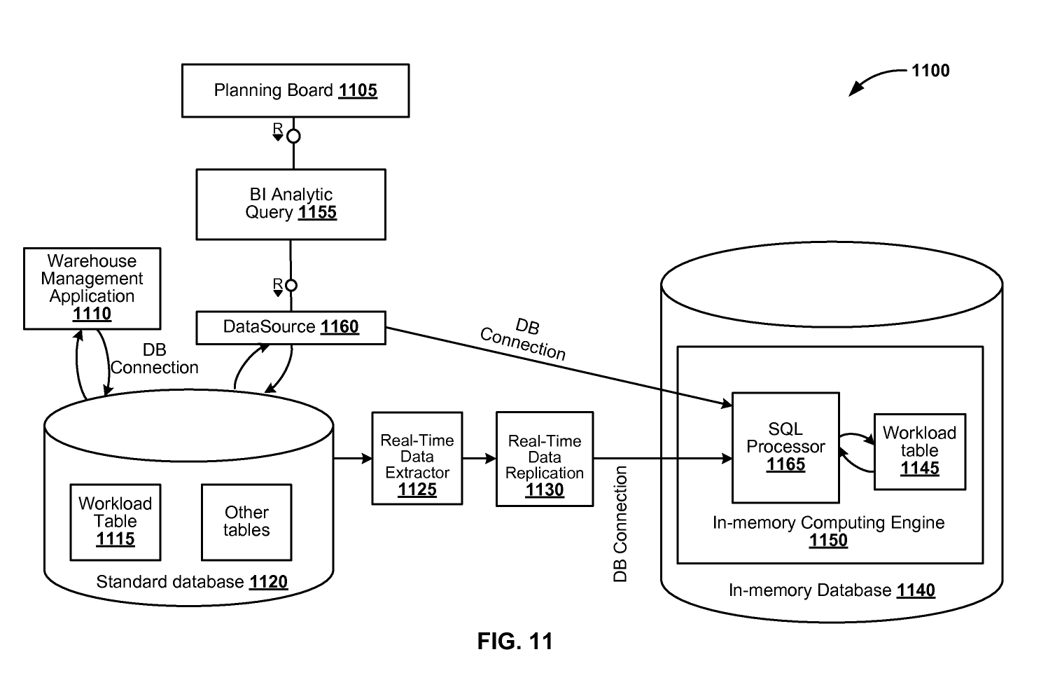

FIG. 11 illustrates system architecture 1100 for real-time activity planning and monitoring of activity execution, according to one embodiment. System architecture 1100 represents a computer system for real-time planning and monitoring of warehouse activities. In one embodiment, warehouse management application 1110 calculates planned activities. Warehouse management application 1110 maintains a database connection with database 1120. In one embodiment, database 1120 is a database management system that employs a nonvolatile storage. Warehouse management application 1110 retains calculated planned activities in workload table 1115. In one embodiment, workload table 1115 is classical row storage based table. Upon change in workload table 1115, real-time data extractor 1125 retrieves the updated workload table 1115. The retrieved workload table 1115 is replicated by real-time data replicator 1130 to workload table 1145 stored in in-memory database 1140. In one embodiment, database 1140 is a database management system that employs a volatile storage. In one embodiment, in-memory database 1140 is based on column store architecture, e.g., SAP® HANA Database provided by SAP AG.

In various embodiments, the in-memory computing engine 1150 may maximize the use of the operative memory provided by modern hardware. Relevant data is kept in the operative memory where read operations can run. The in-memory computing engine 1150 can also be designed to make use of multi core CPUs by parallelization of execution. The in-memory computing engine 1150 can be a hybrid system that reduces the complexity of programming models and system landscapes by combining different paradigms in one system. The in-memory computing engine 1150 comprises engines for column-based, row-based, and object-based in-memory or volatile storage as well as traditional nonvolatile storage. These engines may be integrated in a way that, for example, data from row based storage can be directly combined with data from column based storage. Combining the different engines into a single system may significantly reduce the total cost of ownership. Transaction processing, analytics, planning, simulations, and searching are possible in a single system on the same data. This eliminates the need for separate systems, data extraction and replication in many scenarios. In various embodiments, it is possible to use the in-memory database 1140 as a replacement for standard databases. In one embodiment, standard database 1120 can be replaced with an in-memory database such as the in-memory database 1140 which comprises the in-memory computing engine 1150. In such system setup, real-time data extractor 1125 and real-time data replication 1130 would not be needed. The in-memory database 1140 can act as a full database management system with SQL interface, transactional isolation and recovery and high availability.

In one embodiment, workload table 1145 is an in-memory database table in column store format. With columnar data organization, operations on single columns, such as searching or aggregations can be implemented as loops over an array stored in contiguous memory locations. Such an operation has high spatial locality and can efficiently be executed in the CPU cache. With row oriented storage, the same operation is typically slower because data of the same column is distributed across memory and the CPU is slowed down by cache misses.

In one embodiment, in response to requesting a planning view from planning board 1105, associated BI analytic query 1155 forwards the request to DataSource 1160 via InfoProvider. In one embodiment, DataSource 1160 supply metadata description of source data, e.g., database tables 1115 and 1145. DataSource 1160 may be used to extract data from database 1120 and/or from in-memory database 1140, and to transfer the data to the BI system. In one embodiment, InfoProviders are meta objects in the database that can be uniformly seen as data providers within a query definition, and whose data can also be reported uniformly. In BI systems, aggregation levels are used in planning as InfoProviders. An aggregation level contains a set of characteristics and key figures from a real-time InfoCube. InfoCubes may be defined as objects that can function as both data targets and as InfoProviders. From a reporting point of view, an InfoCube describes a self-contained dataset, for example, of a workload planning. The InfoCube characteristics that are not contained in the aggregation level are aggregated. Selections can be specified for the characteristics in an aggregation level.

In one embodiment, BI analytic query 1155 is linked to DataSource 1160. DataSource 1160 could be an object containing key figures and characteristics, which provides a multidimensional view of business data for reporting. In one embodiment, upon receiving the request, DataSource 1160 calls SQL script that is stored in in-memory database 1140 and is executed by SQL processor 1165. In one embodiment, aggregations and calculation of workload according to processes 700 (FIG. 7) and 900 (FIG. 9) are performed by in-memory computing engine 1150. Calculated workload is returned back to DataSource 1160, which in turn sends the calculated workload to planning board 1105 where it may be presented in a planning view.

In one embodiment, dynamic aggregations and calculations of planned activities on different aggregate levels and filtering are computed by the in-memory computing engine 1150. An example of dynamic calculation that is made real-time by in-memory computing engine 1150 is dynamic calculation or definition of an in-memory time bucket table in response to receiving a request to calculate workload within a time range for a number of buckets. Another example of dynamic calculation by the in-memory computing engine 1150 is the time dependent activity workload function for sets of activities with equal execution timeframes. An example is also the convolution of the time grid and the time dependent activity workload function to spread planned work time consumption of workloads over a number of time buckets. In one embodiment, workload on different aggregate levels is dynamically calculated using in-memory stored data.

In one embodiment, by applying a time grid onto aggregated workload, portions of the persistent workload data stored in table 1115 are not used. Instead, for example, earliest planned start date and time and latest planned date end time may be rounded dynamically to start timestamp and end timestamp of the time buckets of the time grid in in-memory workload table 1145. Also, in case planned earliest start time of a workload is in the past, the planned earliest start time may be rounded to the current or actual date and time. In one embodiment, current date and time may be retrieved from the operating system of the in-memory computing engine 1150.

In one embodiment, planned execution timeframe of individual activities is quantized by allowing only discrete values for earliest start time and latest finish time. Not all values from time continuum are allowed for start and finish time, e.g., start and end timestamps are dynamically rounded to a minute so that not every second or even millisecond is possible as an individual value. If the possible values of the start and finish time are restricted to a number of discrete values, the aggregations are boosted by the column store architecture of the in-memory database 1140. Because only limited number for discrete values for points in time are allowed, the column store calculations are faster. Therefore, when writing activity data into the in-memory database 1140 rounding of the timestamps to the limited number of discrete values is done. Analogous performance boost may be achieved if also the possible values of net execution duration of activities are restricted to discrete values (e.g. 5, 10, 15, 20 seconds, etc.). Further, in case the current date and time is used as an earliest start time of a workload, then also such a dynamic rounding to allowed discrete values is performed.

In one embodiment, workload for a number of time buckets is calculated with sub-second runtime performance, where the workload is calculated based on raw data sample of 1000000 activities. The dynamic calculations and aggregations are boosted by the column store architecture of the in-memory database 1140.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

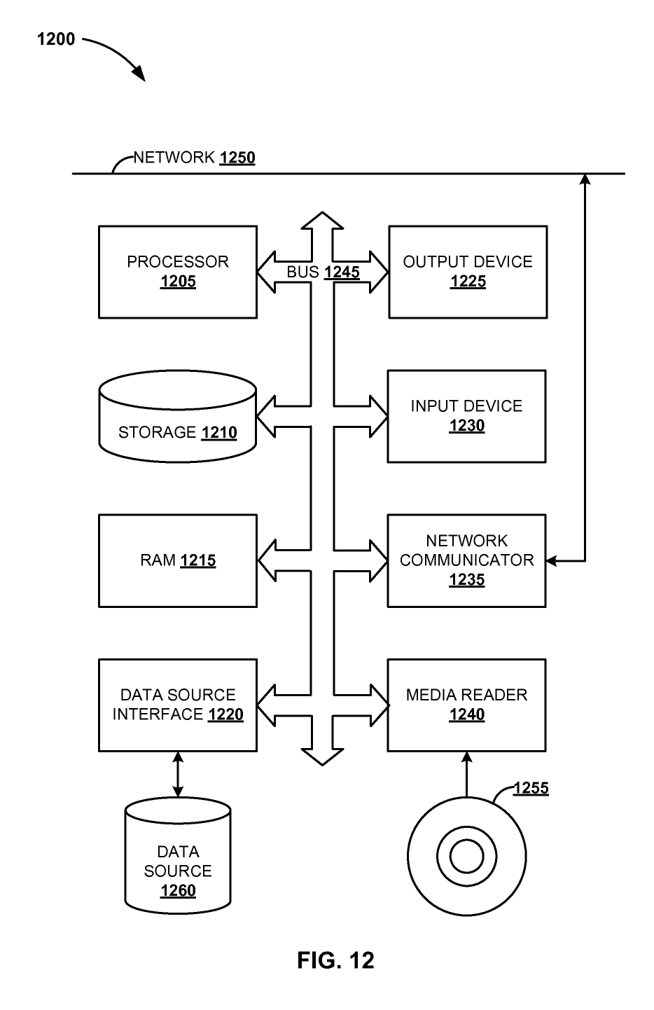

FIG. 12 is a block diagram of an exemplary computer system 1200. The computer system 1200 includes a processor 1205 that executes software instructions or code stored on a computer readable storage medium 1255 to perform the above-illustrated methods. The processor 1205 can include a plurality of cores. The computer system 1200 includes a media reader 1240 to read the instructions from the computer readable storage medium 1255 and store the instructions in storage 1210 or in random access memory (RAM) 1215. The storage 1210 provides a large space for keeping static data where at least some instructions could be stored for later execution. According to some embodiments, such as some in-memory computing system embodiments, the RAM 1215 can have sufficient storage capacity to store much of the data required for processing in the RAM 1215 instead of in the storage 1210. In some embodiments, all of the data required for processing may be stored in the RAM 1215. The stored instructions may be further compiled to generate other representations of the instructions and dynamically stored in the RAM 1215. The processor 1205 reads instructions from the RAM 1215 and performs actions as instructed. According to one embodiment, the computer system 1200 further includes an output device 1225 (e.g., a display) to provide at least some of the results of the execution as output including, but not limited to, visual information to users and an input device 1230 to provide a user or another device with means for entering data and/or otherwise interact with the computer system 1200. Each of these output devices 1225 and input devices 1230 could be joined by one or more additional peripherals to further expand the capabilities of the computer system 1200. A network communicator 1235 may be provided to connect the computer system 1200 to a network 1250 and in turn to other devices connected to the network 1250 including other clients, servers, data stores, and interfaces, for instance. The modules of the computer system 1200 are interconnected via a bus 1245. Computer system 1200 includes a data source interface 1220 to access data source 1260. The data source 1260 can be accessed via one or more abstraction layers implemented in hardware or software. For example, the data source 1260 may be accessed by network 1250. In some embodiments the data source 1260 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to calculate workload for a number of time buckets, the method comprising:
receiving a request to calculate workload for the number of time buckets;
determining one or more sets of activities, wherein an activity is characterized with a net execution duration of the activity and a planned execution timeframe, and wherein each of the one or more sets of activities includes one or more activities with equal execution timeframe;
for each of the one or more sets of activities;
aggregating net execution duration of the included one or more activities to determine a workload;
based on the determined workload, calculating planned work time consumption of the workload; and
distributing, across the number of time buckets, the calculated planned work time consumption of the workload; and
aggregating, by the time buckets, the distributed planned work time consumption of the workloads for the one or more sets of activities to calculate the workload for the time buckets.

2. The method of claim 1, wherein calculating the planned work time consumption of the workload further comprises:
for a set of activities of the one or more sets of activities, dividing aggregated net execution duration of the activities from the set by corresponding equal execution timeframe of the set.

3. The method of claim 1, wherein distributing, across the number of time buckets, the calculated planned work time consumption of the workload further comprises:
determining at least one time bucket from the number of time buckets that overlaps with the workload;
determining a portion of the workload that overlaps with the at least one time bucket;
in proportion to the determined portion, assigning to the at least one time bucket ratio of the planned work time consumption of the workload; and
aggregating the assigned, to the time bucket, planned work time consumption of the workload to determine workload for the time bucket.

4. The method of claim 3, wherein assigning to the at least one time bucket ratio of the planned work time consumption of the workload further comprises:
based on the determined portion of the workload that overlaps with the time bucket, calculating a weight factor by dividing the portion by time length of the time bucket; and
multiplying the planned work time consumption of the workload by the weight factor to determine ratio of the planned work time consumption to assign to the time bucket.

5. The method of claim 1 further comprising:
dynamically calculating the workload for the number of time buckets by an in-memory computing engine.

6. The method of claim 1 further comprising:
in response to the received request, dynamically defining an in-memory table including the number of time buckets with equal time lengths dynamically defined based on the request.

7. The method of claim 1 further comprising:
based on the received request, receiving a selection criteria including filter values of one or more characteristics; and
applying the selection criteria on a number of activities to filter relevant activities according to the selection criteria, wherein the number of activities are stored in an in-memory column store based workload table, and wherein values of net execution duration and earliest start time and latest finish time of execution timeframe of the number of activities are quantized in the workload table.

8. A computer system to calculate workload for a number of time buckets, the system including:
a memory to store computer executable instructions; and
a processor coupled to the memory to execute the instructions to:
receive a request to calculate workload for the number of time buckets;
determine one or more sets of activities, wherein an activity is characterized with a net execution duration of the activity and a planned execution timeframe, and wherein each of the one or more sets of activities includes one or more activities with equal execution timeframe;
for each of the one or more sets of activities;
aggregate net execution duration of the included one or more activities to determine a workload;
based on the determined workload, calculate planned work time consumption of the workload; and
distribute, across the number of time buckets, the calculated planned work time consumption of the workload; and
aggregate, by the time buckets, the distributed planned work time consumption of the workloads for the one or more sets of activities to calculate the workload for the time buckets.

9. The system of claim 8 wherein calculating the planned work time consumption of the workload further comprises:
for a set of activities of the one or more sets of activities, divide aggregated net execution duration of the activities from the set by corresponding equal execution timeframe of the set.

10. The system of claim 8, wherein distributing, across the number of time buckets, calculated planned work time consumption of the workload further comprises:
determine at least one time bucket from the number of time buckets that overlaps with the workload;
determine a portion of the workload that overlaps with the at least one time bucket;
in proportion to the determined portion, assign to the at least one time bucket ratio of the planned work time consumption of the workload; and
aggregate the assigned, to the time bucket, planned work time consumption of the workload to determine workload for the time bucket.

11. The system of claim 10, wherein assigning to the at least one time bucket ratio of the planned work time consumption of the workload further comprises:
based on the determined portion of the workload that overlaps with the time bucket, calculate a weight factor by dividing the portion by time length of the time bucket; and
multiply the planned work time consumption of the workload by the weight factor to determine ratio of the planned work time consumption to assign to the time bucket.

12. The system of claim 8 further to:
dynamically calculate the workload for the number of time buckets by an in-memory computing engine.

13. The system of claim 8 further to:
in response to the received request, dynamically defining an in-memory table including the number of time buckets with equal time lengths dynamically defined based on the request.

14. The system of claim 8 further to:
based on the received request, receive a selection criteria including filter values of one or more characteristics; and
apply the selection criteria on a number of activities to filter relevant activities according to the selection criteria, wherein the number of activities are stored in an in-memory column store based workload table, and wherein values of net execution duration and earliest start time and latest finish time of execution timeframe of the number of activities are quantized in the workload table.

15. A non-transitory computer readable medium storing instructions thereon, which when executed by a processor cause a computer system to:
receive a request to calculate workload for the number of time buckets;
determine one or more sets of activities, wherein an activity is characterized with a net execution duration of the activity and a planned execution timeframe, and wherein each of the one or more sets of activities includes one or more activities with equal execution timeframe;
for each of the one or more sets of activities;
aggregating net execution duration of the included one or more activities to determine a workload;
based on the determined workload, calculating planned work time consumption of the workload; and
distributing, across the number of time buckets, the calculated planned work time consumption of the workload; and
aggregate, by the time buckets, the distributed planned work time consumption of the workloads for the one or more sets of activities to calculate the workload for the time buckets.

16. The computer readable medium of claim 15, wherein calculating the planned work time consumption of the workload further comprises:
for a set of activities of the one or more sets of activities, divide aggregated net execution duration of the activities from the set by corresponding equal execution timeframe of the set.

17. The computer readable medium of claim 15, wherein distributing, across the number of time buckets, calculated planned work time consumption of the workload further comprises:
determine at least one time bucket from the number of time buckets that overlaps with the workload;
determine a portion of the workload that overlaps with the at least one time bucket;
in proportion to the determined portion, assign to the at least one time bucket ratio of the planned work time consumption of the workload; and
aggregate the assigned, to the time bucket, planned work time consumption of the workload to determine workload for the time bucket.

18. The computer readable medium of claim 17, wherein assigning to the at least one time bucket ratio of the planned work time consumption of the workload further comprises:
based on the determined portion of the workload that overlaps with the time bucket, calculate a weight factor by dividing the portion by time length of the time bucket; and
multiply the planned work time consumption of the workload by the weight factor to determine ratio of the planned work time consumption to assign to the time bucket.

19. The computer readable medium of claim 15, wherein the instructions when executed by the processor cause the computer system further to:
dynamically calculate the workload for the number of time buckets by an in-memory computing engine.

20. The computer readable medium of claim 15, wherein the instructions when executed by the processor cause the computer system further to:
in response to the received request, dynamically define an in-memory table including the number of time buckets with equal time lengths dynamically defined based on the request.
